(19) United States
(12) Patent Application Publication
(10) Pub. No.: US 2025/0175778 A1
(43) Pub. Date: May 29, 2025

(54) NOTIFICATION CONTROL DEVICE, NOTIFICATION CONTROL METHOD, AND COMPUTER-READABLE STORAGE MEDIUM

(71) Applicant: NEC Corporation, Minato-ku, Tokyo (JP)

(72) Inventors: Takeshi HISHIYAMA, Tokyo (JP); Tetsuhiro TSUNODA, Tokyo (JP); Toshihiro ENDO, Tokyo (JP)

(73) Assignee: NEC Corporation, Minato-ku, Tokyo (JP)

(21) Appl. No.: 18/839,761

(22) PCT Filed: Feb. 22, 2022
(86) PCT No.: PCT/JP2022/007282

§ 371 Date: Aug. 20, 2024

(51) Int. Cl. H04W 4/90; G08B 25/01

(52) U.S. Cl. CPC H04W 4/90; G08B 25/016

(57) ABSTRACT

A notification control device according to an aspect of the present disclosure includes: a detection circuit that detects a notification from a communication terminal owned by a notifier; a reception circuit that, in accordance with the detection of the notification, receives input of information relating to notification content from the notifier; a determination circuit that, from the input information relating to the notification content, determines whether or not the notification is urgent; and a control circuit that, on the basis of the urgency of the notification, controls the connection destination for the notification.

### TECHNICAL FIELD

The present disclosure relates to a technique for supporting a response at the time of notification.

### BACKGROUND ART

In a case where an accident or the like occurs, a person at the scene of the accident makes a notification to a police station, a fire station, or the like according to the situation. At this time, the person at the scene of the accident makes a call to a police station, a fire station, or the like using his or her own communication terminal, or runs into the nearest police station or the like, for example.

In relation to a case where a person rushes into a police box and makes a notification, PTL 1 discloses that the person to the police box makes a notification using a video phone installed in the police box. At this time, in PTL 1, the visitor is caused to select whether to make an emergency call or normal reception, and in a case where the emergency call is selected, the video phone between the visitor and the operator is connected.

### CITATION LIST

### Patent Literature

PTL 1: WO 2006/016466 A1

### SUMMARY OF INVENTION

### Technical Problem

It is assumed that a person at the scene of the accident makes an emergency notification to a police station, a fire station, and the like using a communication terminal. The emergency notification is received by the emergency notification receiving organization. The emergency notification receiving organization is, for example, a command room of a police station, a fire station, or the like. When the notification is received, the operator of the command room grasps the situation by talking with the notifier. According to the situation, the operator gives a command to an entity to be dispatched such as a police officer, an ambulance team, or a fire-fighting team to come to the site. Since the emergency notification may involve human life, it is necessary for the operator and the entity to be dispatched to quickly take action according to the notification content of the emergency notification.

The initial action of the operator and the entity to be dispatched may be delayed with respect to the emergency notification to be handled. For example, unnecessary and non-urgent notification may be made. When such a notification is made, the operator and the entity to be dispatched are busy with responding to the unnecessary and non-urgent notification. Therefore, there is a possibility that the operator and the entity to be dispatched cannot quickly respond to an emergency notification to be handled, such as a case involving human life.

The present disclosure has been made in view of the above problems, and an object of the present disclosure is to provide a notification control device and the like capable of supporting a quick response to an emergency notification.

### Solution to Problem

A notification control device according to an aspect of the present disclosure includes a detection means for detecting a notification from a communication terminal owned by a notifier, a reception means for receiving an input of information related to notification content from the notifier in accordance with the detection of the notification, a determination means for determining, from the input information related to the notification content, whether the notification is urgent, and a control means for controlling a place where the notification is to be connected based on whether the notification is urgent.

A notification control method according to an aspect of the present disclosure includes detecting a notification by a communication terminal owned by a notifier, receiving an input of information related to notification content from the notifier in response to the detection of the notification, determining, from the input information related to the notification content, whether the notification is urgent, and controlling a place where the notification is to be connected based on whether the notification is urgent.

A computer-readable storage medium according to an aspect of the present disclosure stores a program for causing a computer to execute the steps of detecting a notification by a communication terminal owned by a notifier, receiving an input of information related to notification content from the notifier in response to the detection of the notification, determining, from the input information related to the notification content, whether the notification is urgent, and controlling a place where the notification is to be connected based on whether the notification is urgent.

### Advantageous Effects of Invention

According to the present disclosure, it is possible to support a quick response to an emergency notification.

### BRIEF DESCRIPTION OF DRAWINGS

FIG. 1 is a diagram schematically illustrating an example of a notification mechanism of the present disclosure.

FIG. 2 is a block diagram illustrating an example of a functional configuration of a notification control device according to the first example embodiment of the present disclosure.

FIG. 3 is a flowchart illustrating an example of an operation of the notification control device according to the first example embodiment of the present disclosure.

FIG. 4 is a block diagram illustrating an example of a functional configuration of a notification control device according to the second example embodiment of the present disclosure.

FIG. 5 is a diagram illustrating an example of input reception information according to the second example embodiment of the present disclosure.

FIG. 6 is a diagram illustrating another example of input reception information according to the second example embodiment of the present disclosure.

FIG. 7 is a flowchart illustrating an example of an operation of the notification control device according to the second example embodiment of the present disclosure.

FIG. 8 is a block diagram illustrating an example of a configuration of a notification control device according to the first modification of the present disclosure.

FIG. 9 is a block diagram illustrating another example of a configuration of a notification control device according to the first modification of the present disclosure.

FIG. 10 is a block diagram illustrating an example of a functional configuration of a notification control device according to the third example embodiment of the present disclosure.

FIG. 11 is a diagram illustrating an example of output information according to the third example embodiment of the present disclosure.

FIG. 12 is a flowchart illustrating an example of an operation of the notification control device according to the third example embodiment of the present disclosure.

FIG. 13 is a block diagram illustrating an example of a functional configuration of a notification control device according to the fourth example embodiment of the present disclosure.

FIG. 14 is a diagram illustrating an example of second input reception information according to the fourth example embodiment of the present disclosure.

FIG. 15 is a diagram illustrating an example of output information according to the fourth example embodiment of the present disclosure.

FIG. 16 is a flowchart illustrating an example of an operation of the notification control device according to the fourth example embodiment of the present disclosure.

FIG. 17 is a block diagram illustrating an example of a hardware configuration of a computer device that achieves the notification control device according to each of the first, the second, the third, and the fourth example embodiments of the present disclosure.

### EXAMPLE EMBODIMENT

Hereinafter, example embodiments of the present disclosure will be described with reference to the drawings.

### First Example Embodiment

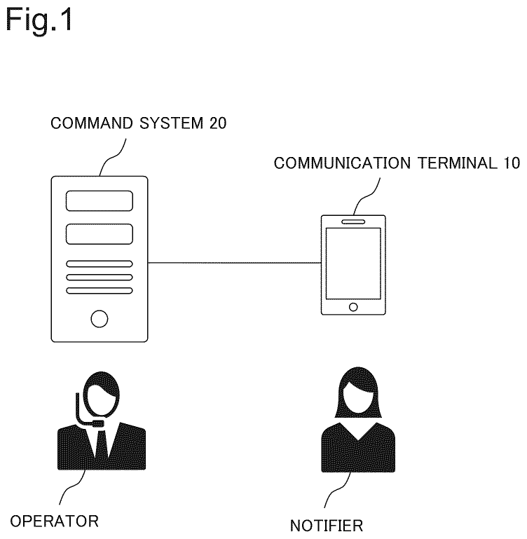

First, a notification mechanism will be described. FIG. 1 is a diagram schematically illustrating an example of a notification mechanism. A communication terminal 10 and a command system 20 are communicably connected via a wired or wireless network. The notifier makes a notification by inputting a predetermined telephone number or the like using the communication terminal 10, for example. The communication terminal 10 is, for example, a portable terminal such as a cellular phone, a smartphone, and a tablet terminal. The present invention is not limited to this example, and the communication terminal 10 may be a personal computer. The communication terminal 10 is a terminal having at least a function of making a notification.

The notification destination is, for example, an emergency notification receiving organization. The notification destination indicates an organization that issues a dispatch command to an entity to be dispatched (for example, a police officer, a fire-fighting team, an ambulance team, and the like) to arrive at the site according to the content of the notification. The notification is connected to a command system 20 in a command room of a police station, a fire station, or the like that is an example of an emergency notification receiving organization. The command system 20 may be, for example, a server device or a device group including the server device. The operator in the command room makes a call with the notifier via the command system 20. The operator gives an instruction to the notifier based on the information obtained from the notifier, or gives an instruction to the entity to be dispatched using the command system 20. The notification control device of the present disclosure is used in a situation where such a notification is made as an example.

Next, an outline of the notification control device of the present disclosure will be described.

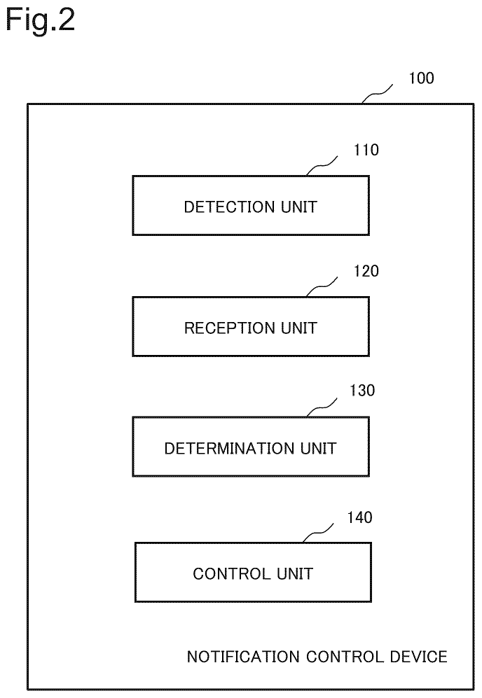

FIG. 2 is a block diagram illustrating an example of a functional configuration of a notification control device 100. The notification control device 100 is, for example, a device that can be communicably connected to the communication terminal 10 and the command system 20 in a wired or wireless manner. The notification control device 100 may be a device external to the communication terminal 10 and the command system 20, or may be a device incorporated in the communication terminal 10 or the command system 20.

As illustrated in FIG. 2, the notification control device 100 includes a detection unit 110, a reception unit 120, a determination unit 130, and a control unit 140.

The detection unit 110 detects a notification by the communication terminal 10. For example, the communication terminal 10 transmits a signal for making a notification. When the signal is received by the command system 20, communication by a call between the communication terminal 10 and the command system 20 is connected. For example, the detection unit 110 may detect the notification by detecting that the signal is transmitted before the communication by the call is connected. The detection unit 110 may detect the notification by detecting that the communication terminal 10 has received the operation of the notification from the user. In this manner, the detection unit 110 detects a notification by the communication terminal 10 owned by the notifier. The detection unit 110 is an example of a detection means.

The reception unit 120 receives an input from the notifier in response to detection of the notification. For example, when notification is detected, the reception unit 120 outputs input reception information for receiving an input from the notifier to the communication terminal 10. The input reception information may be, for example, information in which an item for receiving an input of information related to notification content is displayed. For example, the notifier operates the input reception information to input information related to notification content. The reception unit 120 receives, for example, information related to notification content input in this manner. In this manner, the reception unit 120 receives an input of information related to notification content from the notifier in response to detection of the notification. The reception unit 120 is an example of a reception means.

The determination unit 130 determines whether the notification is urgent. For example, it is assumed that information indicating that an injured person is present is included in the information related to the input notification content. In this case, the determination unit 130 may determine that there is urgency in the notification, assuming that the notification relates to human life. For example, it is assumed that information indicating that the notification is for the purpose of consultation is included in the information related to the input notification content. In this case, the determination unit 130 may determine that there is no urgency in the notification. In this manner, the determination unit 130 determines whether the notification is urgent from the input information related to the notification content. The determination unit 130 is an example of a determination means.

The control unit 140 controls a place where the notification is to be connected. For example, in a case where the determination unit 130 determines that there is an emergency in the notification, the control unit 140 connects the notification to the command system 20 in the command room that is an emergency notification receiving organization. For example, in a case where the determination unit 130 determines that there is no urgency in the notification, the control unit 140 connects the notification to a connection place different from the emergency notification receiving organization. The connection place different from the emergency notification receiving organization is, for example, a system of a consultation counter installed in a public institution. An example of the connection place in a case where it is determined that there is no urgency is not limited to this example. In this manner, the control unit 140 controls a place where the notification is to be connected based on whether the notification is urgent. The control unit 140 is an example of a control means.

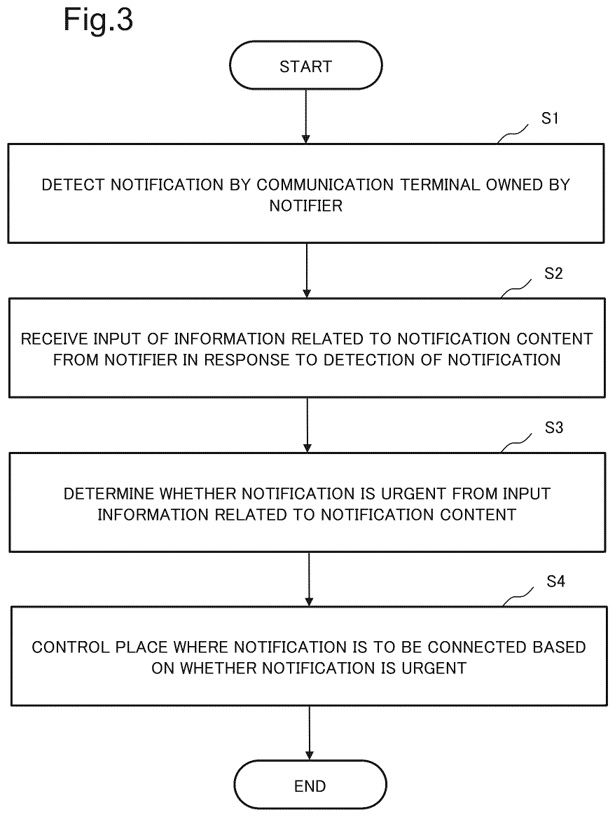

Next, an example of the operation of the notification control device 100 will be described with reference to FIG. 3. In the present disclosure, each step in the flowchart is represented using a number assigned to each step, such as “S1”.

FIG. 3 is a flowchart for describing an example of the operation of the notification control device 100. The detection unit 110 detects a notification by a communication terminal owned by the notifier (S1). In response to the detection of the notification, the reception unit 120 receives an input of information related to the notification content from the notifier (S2). The determination unit 130 determines whether the notification is urgent from the input information related to the notification content (S3). The control unit 140 controls a place where the notification is to be connected based on whether the notification is urgent (S4).

As described above, the notification control device 100 according to the first example embodiment detects a notification by the communication terminal owned by the notifier, and receives an input of information related to notification content from the notifier in response to detection of the notification. The notification control device 100 determines whether the notification is urgent from the input information related to the notification content, and controls a place where the notification is to be connected based on whether the notification is urgent. As a result, the notification control device 100 can change a place where the notification is to be connected according to, for example, whether the notification from the notifier is an urgent notification or an unnecessary and non-urgent notification. For example, in a case where it is determined that the notification requires urgency, the notification control device 100 can set a place where the notification is to be connected to an emergency notification receiving organization. For example, in a case where it is determined that notification is unnecessary and non-urgent, the notification control device 100 can set a place where the notification is to be connected to a consultation counter or the like different from the emergency notification receiving organization. Therefore, the notification control device 100 can suppress the frequency at which unnecessary and non-urgent notifications are connected to the emergency notification receiving organization. Furthermore, since the notification control device 100 does not cause the notifier to select whether notification is urgent or unnecessary and nonurgent, it is also possible to prevent the notifier from making a notification as urgent even though it is unnecessary and nonurgent. Therefore, the emergency notification receiving organization, the entity to be dispatched, and the like can quickly respond to an urgent notification. That is, the notification control device 100 can support rapid handling of the emergency notification.

### Second Example Embodiment

Next, a notification control device according to the second example embodiment will be described. In the second example embodiment, the notification control device 100 described in the first example embodiment will be described in more detail. Description of content overlapping with the content described in the first example embodiment will be partially omitted.

### Details of Notification Control Device 100

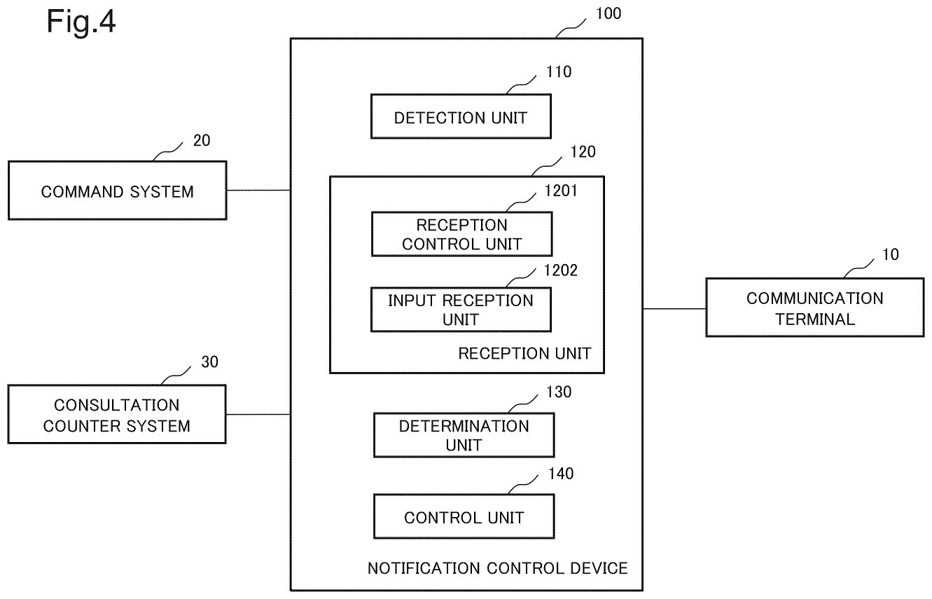

FIG. 4 is a block diagram illustrating an example of a functional configuration of the notification control device 100. As illustrated in FIG. 4, the notification control device 100 can communicate with the communication terminal 10, the command system 20, and a consultation counter system 30. Note that, as described above, the configuration of the notification control device 100 is not limited to this example. In the present disclosure, an example in which the notification control device 100 is a device outside the communication terminal 10 and the command system 20 as illustrated in FIG. 4 will be mainly described.

The notification control device 100 includes the detection unit 110, the reception unit 120, the determination unit 130, and the control unit 140.

The detection unit 110 detects a notification by the communication terminal 10. The detection unit 110 detects a notification before communication between the communication terminal 10 and the command system 20 is established. For example, it is assumed that a notifier made a call by inputting a telephone number of an emergency notification receiving organization. At this time, the detection unit 110 determines whether the input telephone number is a telephone number of the emergency notification receiving organization. In a case where the input telephone number is the telephone number of the emergency notification receiving organization, the detection unit 110 may detect that the communication terminal 10 made a call as a notification from the communication terminal 10. The method of detecting the notification is not limited to this example. The detection unit 110 may detect that an operation for making a notification to the emergency notification receiving organization has been performed by the communication terminal 10.

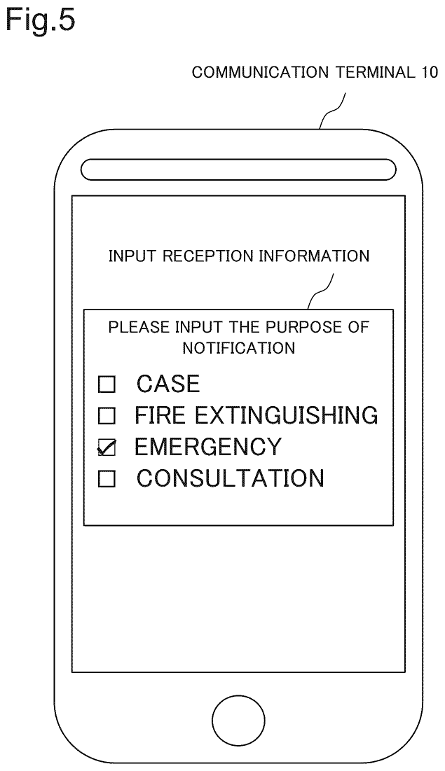

The reception unit 120 includes a reception control unit 1201 and an input reception unit 1202. The reception control unit 1201 outputs the input reception information to the communication terminal 10. The input reception information is information for prompting the notifier to input information related to notification content. FIG. 5 is a diagram illustrating an example of input reception information. In the example of FIG. 5, input reception information is displayed on a display included in the communication terminal 10. The input reception information includes a sentence “Please input the purpose of notification” and check boxes for selecting items of “case”, “fire extinguishing”, “emergency”, and “consultation”. In this manner, the input reception information may be information for inputting the purpose of notification. In the example of FIG. 5, the item “emergency” is selected. That is, in this example, it is indicated that the notification is a notification for emergency.

The input reception unit 1202 receives an input from the notifier. More specifically, the input reception unit 1202 receives an input of information related to notification content by receiving an operation by the notifier with respect to the input reception information. In the example of FIG. 5, the input reception unit 1202 receives an input of information indicating that the purpose of notification is “emergency” as the information related to the notification content.

The example of the information related to the notification content received from the notifier is not limited to this example. For example, the input reception information may include information for inputting an event that triggers the notification. For example, the reception control unit 1201 causes the communication terminal 10 to display items such as “case”, “accident”, “fire”, and “trouble”. The notifier selects an item, and the input reception unit 1202 receives information related to notification content. For example, in a case where the notifier selects “fire”, the input reception unit 1202 receives an input of information indicating that the event that triggered the notification is “fire” as the information related to the notification content. Examples of the event that triggered the notification may be further subdivided events such as a traffic accident, a marine accident, parking violation, stoker damage, and noise trouble.

The reception control unit 1201 may input both the purpose of notification and the event that triggered the notification. In this case, the input reception unit 1202 receives an input of information indicating each of the purpose of notification and the event that triggered the notification as the information related to the notification content. In this manner, the reception unit 120 may receive input of at least one of the purpose of notification and the type of the event that triggered the notification.

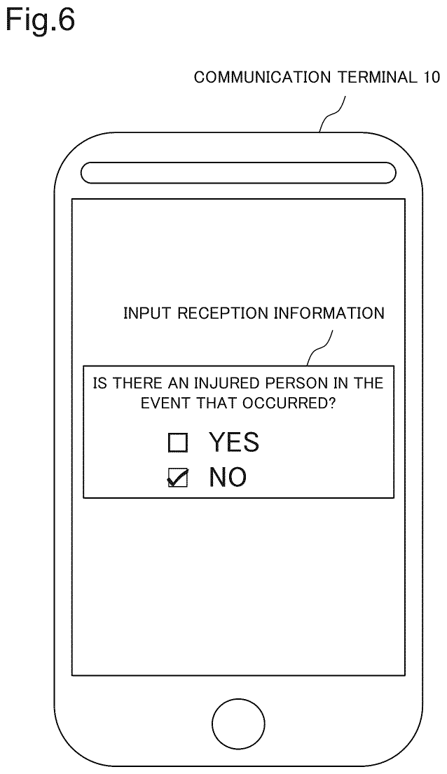

Further, the input reception information may include information for inputting information related to the injured person. FIG. 6 is a diagram illustrating another example of the input reception information.

In the example of FIG. 6, a sentence “Is there an injured person in the occurred event?” and a check box for selecting an item of “Yes” or “No” are displayed on the display of the communication terminal 10. In this example, “No” is selected. In this case, the input reception unit 1202 receives an input of information indicating that “no” injured person is present as the information related to the notification content. In this manner, the reception unit 120 may receive an input of the presence or absence of an injured person. The reception unit 120 may receive an input of the number of injured persons.

The determination unit 130 determines whether the notification is urgent. For example, it is assumed that information indicating a purpose of notification is included in information related to notification content. For example, in a case where the purpose of the notification is emergency, the determination unit 130 determines that there is urgency in the notification. On the other hand, in a case where the purpose of the notification is “consultation”, the determination unit 130 may determine that there is no urgency in the notification.

It is assumed that information indicating an event that triggered notification is included in the information related to the notification content. For example, in a case where the event that triggered the notification is a fire, the determination unit 130 determines that there is urgency in the notification. On the other hand, in a case where the event is a trouble, the determination unit 130 may determine that there is no urgency in the notification.

In a case where the purpose of the notification is an accident and the event is a marine accident, the determination unit 130 may determine that there is urgency in the notification. On the other hand, in a case where the purpose of the notification is an accident and the event is parking violation, the determination unit 130 may determine that there is no urgency in the notification. In this manner, the determination unit 130 may determine whether the notification is urgent according to the received purpose or event type.

It is assumed that the information related to the notification content includes information related to the injured person. For example, in a case where there is an injured person, the determination unit 130 determines that there is urgency in the notification. On the other hand, in a case where there is no injured person, the determination unit 130 may determine that there is no urgency in the notification. In this manner, the determination unit 130 may determine whether the notification is urgent according to the presence or absence of the injured person.

The determination method is not limited to the above example. For example, the determination unit 130 may determine a numerical value for each item input as information related to notification content, and determine whether the notification is urgent according to an evaluation value based on the numerical value. For example, in a case where the purpose of notification is an accident, one is set. Two is set in a case where the event is a marine accident, and zero is set in a case where the event is parking violation. According to the input from the notifier, in a case where the purpose of the notification is an accident and the event is a marine accident, the determination unit 130 sets the evaluation value of the notification to three that is the sum of numerical values. In a case where the purpose of the notification is an accident and the event is parking violation according to the input from the notifier, the determination unit 130 sets the evaluation value of the notification to one. In a case where the evaluation value is equal to or more than two, the determination unit 130 may determine that there is urgency in the notification. In this manner, the determination unit 130 may determine whether the notification is urgent according to whether the evaluation value based on the numerical value set for each item exceeds the predetermined threshold value.

The determination unit 130 may make a determination by giving priority to the presence or absence of an injured person. For example, the determination unit 130 may determine that there is urgency in notification in a case where there is an injured person regardless of the purpose of the notification and the event that triggered the notification. In this manner, the determination unit 130 may determine whether the notification is urgent depending on whether there is specific information in the information related to the notification content.

The control unit 140 controls a place where the notification is to be connected. In a case where the determination unit 130 determines that there is urgency in the notification, the control unit 140 connects the notification to the command system 20 of the command room that is an emergency notification receiving organization. For example, in a case where the determination unit 130 determines that there is no urgency in the notification, the control unit 140 connects the notification to a connection place different from the emergency notification receiving organization. The connection place different from the emergency notification receiving organization is, for example, a consultation counter system 30 installed in a public institution. The consultation counter system 30 may be, for example, an automatic response call center. In this case, the consultation counter system 30 may connect the notification to the call center operator after receiving the input from the notifier through the automatic response.

An example of control of the connection place will be described. For example, it is assumed that a notifier makes a notification to the police. In Japan, when a telephone call is made by inputting “110”, the telephone call is connected to an emergency notification receiving organization of the police. In a case where it is determined that there is an emergency in the notification, the control unit 140 sets, for example, a place where the notification is to be connected to an emergency notification receiving organization of the police. On the other hand, in a case where it is determined that there is no urgency in the notification, the control unit 140 does not set a place where the notification is to be connected to the emergency notification receiving organization of the police. At this time, the control unit 140 sets a place where the notification is to be connected to a consultation counter of the police. For example, in Japan, when a telephone call is made by inputting “#9110”, the telephone call is connected to a consultation counter of the police. In a case where it is determined that there is no urgency in the notification, the control unit 140 may connect the notification to the consultation counter. The control of the connection place is not limited to this example.

### Operation Example of Notification Control Device 100

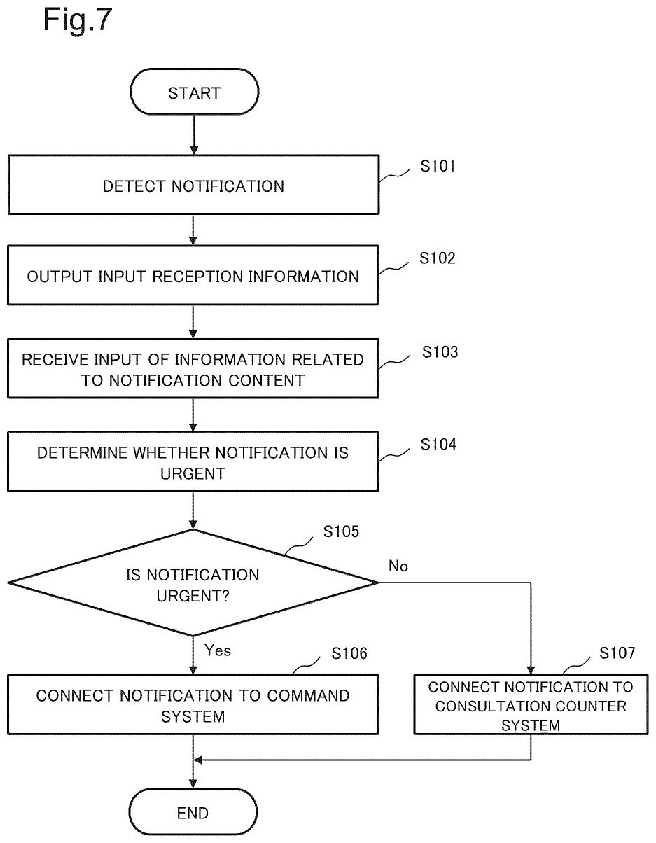

Next, an example of the operation of the notification control device 100 will be described with reference to FIG. 7.

FIG. 7 is a flowchart for describing an example of the operation of the notification control device 100. First, the detection unit 110 detects a notification by the communication terminal 10 (S101). When the notification is detected, the reception control unit 1201 outputs the input reception information to the communication terminal 10 (S102). The input reception unit 1202 receives an input of information related to a notification content by an operation on the input reception information by the notifier (S103). The determination unit 130 determines whether the notification is urgent based on the information related to the received notification content (S104).

In a case where it is determined that there is urgency in the notification (“Yes” in S105), the control unit 140 connects the notification to the command system 20 in the command room that is an emergency notification receiving organization (S106). On the other hand, in a case where it is determined that there is no urgency in the notification (“No” in S105), the control unit 140 connects the notification to the consultation counter system 30 (S106).

As described above, the notification control device 100 according to the second example embodiment detects a notification by the communication terminal owned by the notifier, and receives an input of information related to notification content from the notifier in response to detection of the notification. The notification control device 100 determines whether the notification is urgent from the input information related to the notification content, and controls a place where the notification is to be connected based on whether the notification is urgent. As a result, the notification control device 100 can change a place where the notification is to be connected according to, for example, whether the notification from the notifier is an urgent notification or an unnecessary and non-urgent notification. For example, in a case where it is determined that the notification requires urgency, the notification control device 100 can set a place where the notification is to be connected to an emergency notification receiving organization. For example, in a case where it is determined that notification is unnecessary and non-urgent, the notification control device 100 can set a place where the notification is to be connected to a consultation counter or the like different from the emergency notification receiving organization. Therefore, the notification control device 100 can suppress the frequency at which unnecessary and non-urgent notifications are connected to the emergency notification receiving organization. Furthermore, since the notification control device 100 does not cause the notifier to select whether notification is urgent or unnecessary and nonurgent, it is also possible to prevent the notifier from making a notification as urgent even though it is unnecessary and nonurgent. Therefore, the emergency notification receiving organization, the entity to be dispatched, and the like can quickly respond to an urgent notification. That is, the notification control device 100 can support rapid handling of the emergency notification.

The notification control device 100 according to the second example embodiment may connect the notification to the emergency notification receiving organization in a case where it is determined that there is urgency in the notification, and connect the notification to a connection place different from the emergency notification receiving organization in a case where it is determined that there is no urgency in the notification. As a result, the notification control device 100 can connect only a notification with urgency to the emergency notification receiving organization. Therefore, the notification control device 100 can reduce the frequency at which the emergency notification receiving organization and the entity to be dispatched have to make an unnecessary and non-urgent response.

The notification control device 100 according to the second example embodiment may receive an input of at least one of a purpose of notification and a type of an event that triggered the notification, and determine whether the notification is urgent according to the received purpose or the received type of the event. The notification control device 100 may receive an input of the presence or absence of an injured person and determine whether the notification is urgent according to the presence or absence of the injured person. As a result, the notification control device 100 can cause the notifier to input only objective information without making the notifier determine urgency. That is, the notification control device 100 can reduce the frequency at which the notifier makes a notification as an emergency even though the notification is an unnecessary and non-urgent notification.

### First Modification

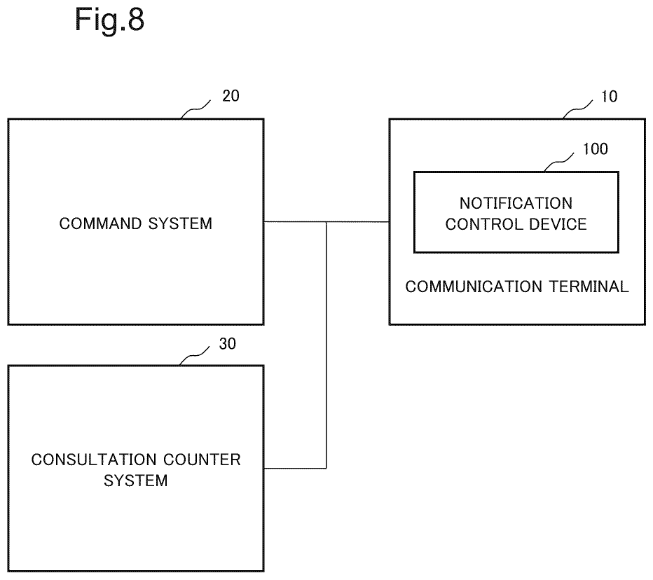

As described above, the notification control device 100 can be implemented by various methods. FIG. 8 is a block diagram illustrating an example of a configuration of a notification control device according to a first modification. For example, as illustrated in FIG. 8, the notification control device 100 may be included in the communication terminal 10. In this case, for example, the detection unit 110 may detect the notification by detecting an operation of making the notification in the communication terminal 10.

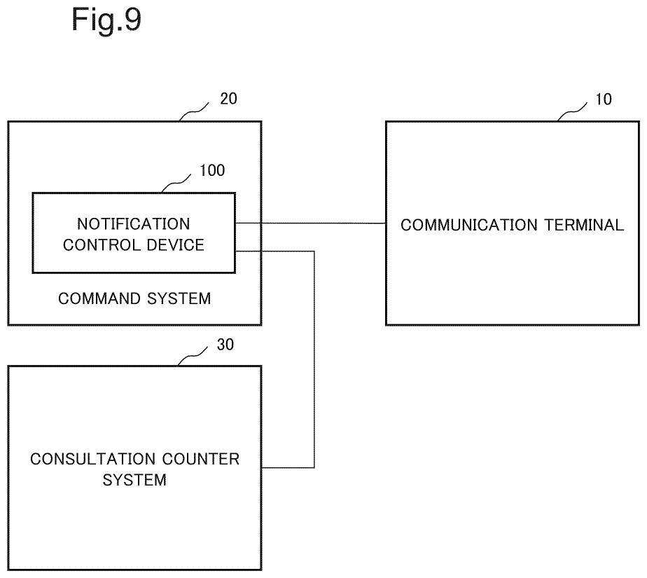

FIG. 9 is a block diagram illustrating another example of the configuration of the notification control device according to the first modification. For example, as illustrated in FIG. 9, the notification control device 100 may be included in the command system 20. In this case, communication is connected once between the communication terminal 10 and the command system 20. In a case where the notification control device 100 determines that there is no urgency in the notification, for example, a place where the notification is to be connected is switched to the consultation counter system 30.

### Third Example Embodiment

Next, a notification control device according to the third example embodiment will be described. In the third example embodiment, an example of a further function of the notification control device will be described. Description of content overlapping with the content described in the first and second example embodiments will be partially omitted.

### Details of Notification Control Device 101

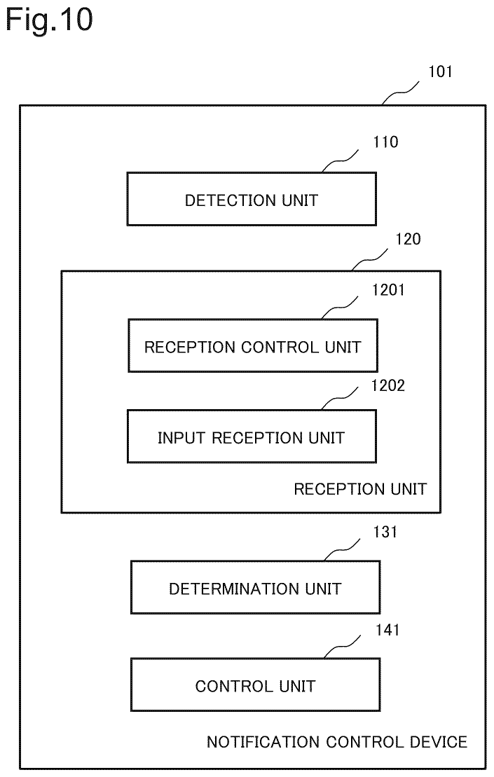

FIG. 10 is a block diagram illustrating an example of a functional configuration of a notification control device 101. In the present example embodiment, the notification control device 101 is present instead of the notification control device 100 illustrated in FIG. 4, for example. That is, the notification control device 101 can communicate with the communication terminal 10, the command system 20, and the consultation counter system 30.

As illustrated in FIG. 10, the notification control device 101 includes a detection unit 110, a reception unit 120, a determination unit 131, and a control unit 141. The notification control device 101 may perform processing described below in addition to the processing of the notification control device 100.

The determination unit 131 determines whether information indicating a notification source of the notification is included in the list. The information indicating the notification source is, for example, a telephone number. For example, the determination unit 131 determines whether the list includes the telephone number of the communication terminal 10 that is the notification source. The information indicating the notification source is not limited to the telephone number, and may be any information that can identify the notifier or the communication terminal 10 when notification is made. The list may be generated in advance or may be generated by a list generation unit to be described later.

The list is information including information indicating a notification source. For example, the list may be information indicating a list of telephone numbers. Notification of mischief may be made. The list includes, for example, a list of telephone numbers of communication terminals through which a notification is made of mischief. The information included in the list is not limited to the telephone number of the communication terminal through which a notification is made of mischief. The list may include information indicating a notification source having a high possibility of making an unnecessary and non-urgent notification. The list may be stored in a storage device (not illustrated) included in the notification control device 101, or may be stored in an external device communicable with the notification control device 101.

The determination unit 131 may perform both determination as to whether there is urgency of notification and determination as to whether information indicating a notification source is included in the list. The determination unit 131 may determine whether the notification is urgent in a case where the information indicating the notification source is not included in the list. In this case, the processing of the reception unit 120 may be performed in a case where the information indicating the notification source is not included in the list.

In a case where information indicating a notification source of the notification is included in the list, the control unit 141 may perform control so as not to connect the notification to the emergency notification receiving organization. For example, the control unit 141 may connect the notification to the consultation counter system 30 or may disconnect the notification. In a case of disconnecting the notification, the control unit 141 may output, to the communication terminal 10, voice guidance indicating disconnection. The control unit 141 may prioritize determination of whether information indicating a notification source is included in the list rather than determination of urgency of the notification. That is, the control unit 141 may perform control so as not to connect the notification to the emergency notification receiving organization in a case where the information indicating the notification source is included in the list regardless of the presence or absence of the determined urgency.

### Operation Example of Notification Control Device 101

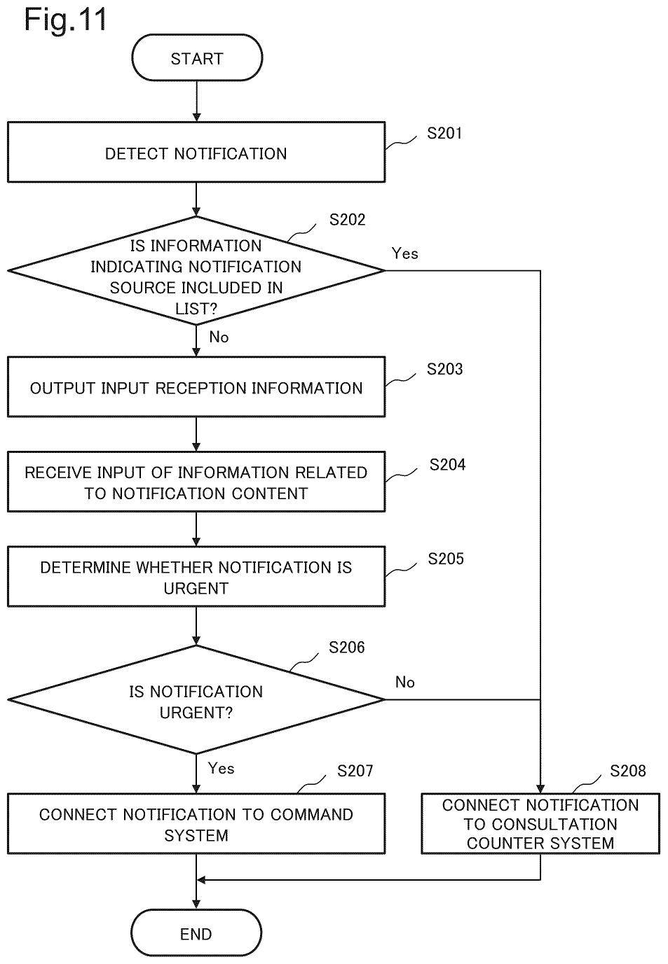

Next, an example of the operation of the notification control device 101 will be described with reference to FIG. 11.

FIG. 11 is a flowchart illustrating an example of the operation of the notification control device 101. First, the detection unit 110 detects a notification by the communication terminal 10 (S101). The determination unit 131 determines whether information indicating a notification source is included in the list. In a case where the information indicating the notification source is included in the list (“Yes” in S202), the control unit 141 connects the notification to the consultation counter system 30 (S208).

On the other hand, in a case where the information indicating the notification source is not included in the list (“No” in S202), the notification control device 101 performs the processing in S203 and subsequent steps. The processing of S203 to S208 is similar to the processing of S102 to S107 of FIG. 7, and thus description thereof is omitted.

As described above, the notification control device 101 according to the third example embodiment determines whether the list includes the information indicating the notification source of the notification, and performs control not to connect the notification to the emergency notification receiving organization in a case where the list includes the information indicating the notification source. As a result, the notification control device 101 can perform control so as not to connect the notification from the communication terminal of the notifier who has made unnecessary notification such as mischief in the past to the emergency notification receiving organization, for example. Therefore, the notification control device 101 can reduce the frequency at which the emergency notification receiving organization and the entity to be dispatched have to make an unnecessary and non-urgent response.

### Second Modification

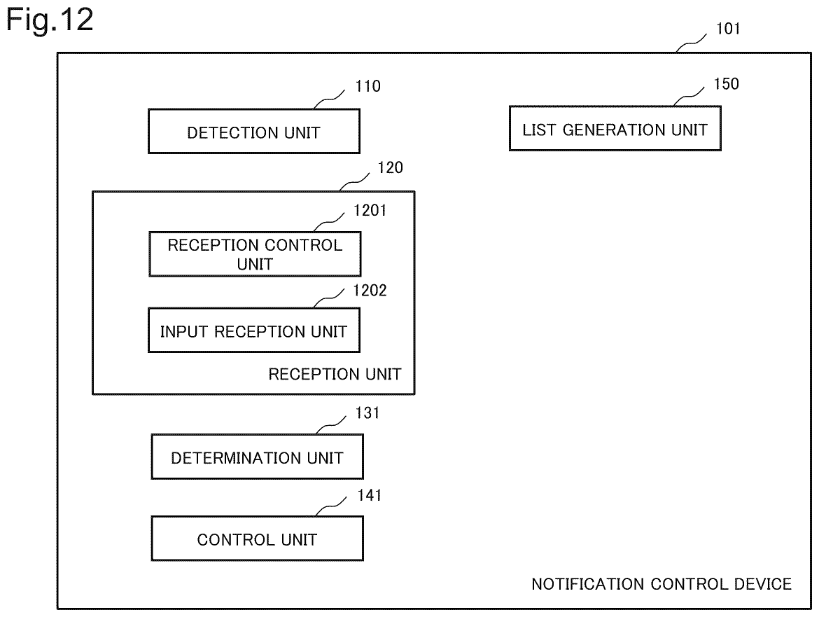

The notification control device 101 may include a list generation unit 150. FIG. 12 is a block diagram illustrating an example of a functional configuration of the notification control device 101 according to the second modification.

The list generation unit 150 generates a list. For example, an operator of a command room that is an emergency notification receiving organization or an operator of a consultation counter receives the notification. At this time, in a case where the notification is mischief, the operator who has received the notification inputs information indicating that the notification is mischief using the command system 20 or the consultation counter system 30. The list generation unit 150 acquires information indicating the notification source of the notification source who made the notification that is mischief. In a case where mischief notifications are made from the same notification source a predetermined number of times or more, the list generation unit 150 generates a list including information indicating a notification source of the notification source that has made a notification a predetermined number of times or more.

### Fourth Example Embodiment

Next, a notification control device according to the fourth example embodiment will be described. In the fourth example embodiment, an example of a further function of the notification control device in a case where a notification is connected to an emergency notification receiving organization will be described. Description of content overlapping with the content described in the first, second, and the third example embodiments will be partially omitted.

### Details of Notification Control Device 102

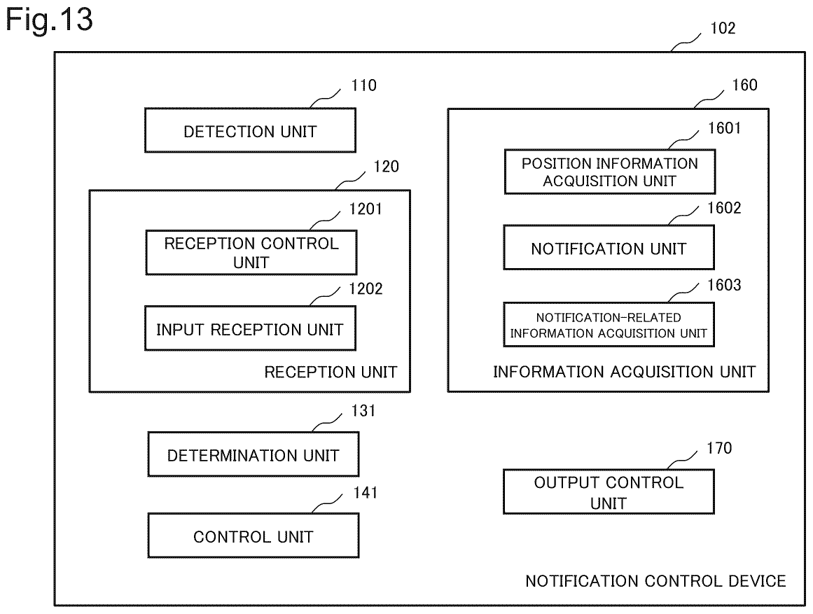

FIG. 13 is a block diagram illustrating an example of a functional configuration of a notification control device 102. In the present example embodiment, the notification control device 102 is present instead of the notification control device 100 illustrated in FIG. 4, for example. That is, the notification control device 102 can communicate with the communication terminal 10, the command system 20, and the consultation counter system 30. The notification control device 102 can also communicate with another communication terminal different from the communication terminal 10.

As illustrated in FIG. 13, the notification control device 102 includes a detection unit 110, a reception unit 120, a determination unit 131, a control unit 141, an information acquisition unit 160, and an output control unit 170. The notification control device 102 may perform processing described below in addition to the processing by the notification control device 100 or the notification control device 101.

The information acquisition unit 160 includes a position information acquisition unit 1601, a notification unit 1602, and a notification-related information acquisition unit 1603. The position information acquisition unit 1601 acquires position information of the communication terminal 10. For example, the position information acquisition unit 1601 acquires the position information of the communication terminal 10 as the notification source in response to the detection of the notification by the detection unit 110. The position information acquisition unit 1601 acquires position information of the another communication terminal. The position information acquisition unit 1601 may acquire the position information from a plurality of communication terminals including the communication terminal 10 and the another communication terminal in response to detection of the notification. The plurality of communication terminals is provided with a function capable of identifying position information of the communication terminals by a global navigation satellite system (GNSS) such as a global positioning system (GPS). For example, the position information acquisition unit 1601 acquires the position information identified by the function as the position information of the entity to be dispatched. The position information acquisition unit 1601 may periodically acquire the position information from the communication terminal 10 and the another communication terminal. In this case, for example, in response to detection of the notification, the position information acquisition unit 1601 identifies the position information of the communication terminal 10 as the notification source among the acquired position information.

The notification unit 1602 makes a notification to the another communication terminal. Specifically, the notification unit 1602 identifies the another communication terminal present within a predetermined range from the communication terminal 10. For example, the notification unit 1602 identifies position information indicating a predetermined range from the position indicated by the position information of the communication terminal 10 among the acquired position information. The notification unit 1602 identifies the another communication terminal present at the position indicated by the identified position information.

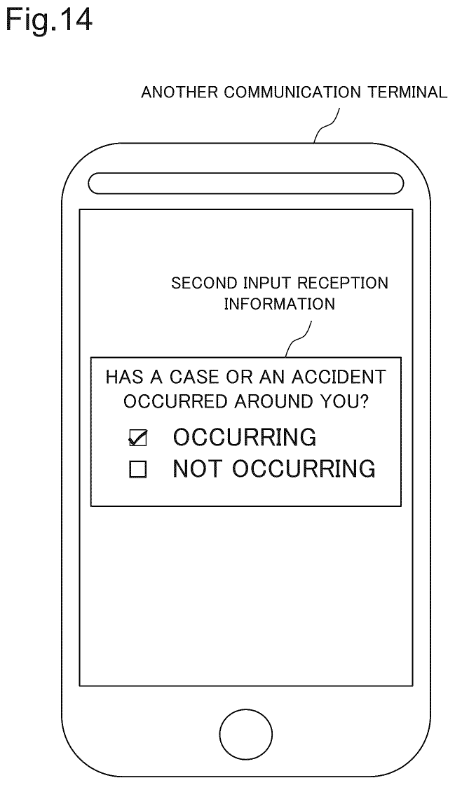

The notification unit 1602 notifies the identified another communication terminal of a notification to input information related to the notification. More specifically, the notification unit 1602 transmits the second input reception information to the identified another communication terminal. FIG. 14 is a diagram illustrating an example of the second input reception information. In the example of FIG. 14, a sentence “Has a case or an accident occurred around you?” and a check box for selecting an item of “occurring” or “not occurring” are displayed on a display of the another communication terminal. In this example, “occurring” is selected.

The notification-related information acquisition unit 1603 acquires the notification-related information. The notification-related information is information related to notification. Specifically, the notification-related information acquisition unit 1603 acquires the notification-related information as a response to the input reception information notified by the notification unit 1602. For example, in the example of FIG. 14, since “occurring” is selected, the notification-related information acquisition unit 1603 acquires information indicating that a case or an accident has occurred as the notification-related information.

In this manner, the information acquisition unit 160 acquires the position information from the communication terminal 10 and a terminal different from the communication terminal 10. The information acquisition unit 160 acquires information related to notification from the another communication terminal present in a predetermined range from the position indicated by the position information of the communication terminal 10. The information acquisition unit 160 is an example of an information acquisition means.

The notification-related information acquired by the information acquisition unit 160 is not limited to the above example. For example, the notification unit 1602 may transmit second input reception information including information for inputting details of a case or an accident to the another communication terminal. In this case, the owner of the another communication terminal inputs details of the case or the accident. Details of the case or the accident include a type of the case or the accident, a place where the case or the accident occurred, and the presence or absence of an injured person. The notification-related information acquisition unit 1603 acquires information including details of the case or the accident as the notification-related information.

The information acquisition unit 160 may make a notification before connection of notification by the communication terminal 10. That is, before the notification is connected, the information acquisition unit 160 may transmit a notification for receiving an input of information related to the notification to the another communication terminal, and acquire the information related to the notification as a response to the notification. In this manner, the information acquisition unit 160 can acquire information related to notification more quickly by making a notification before connection of the notification.

The output control unit 170 outputs the output information. For example, the output control unit 170 outputs output information including notification-related information to a display device such as a display included in the command system 20. The display device is a device that allows an operator of the command system 20 or an entity to be dispatched to visually recognize the display device. Therefore, the operator of the command system 20 or the entity to be dispatched can confirm the notification-related information.

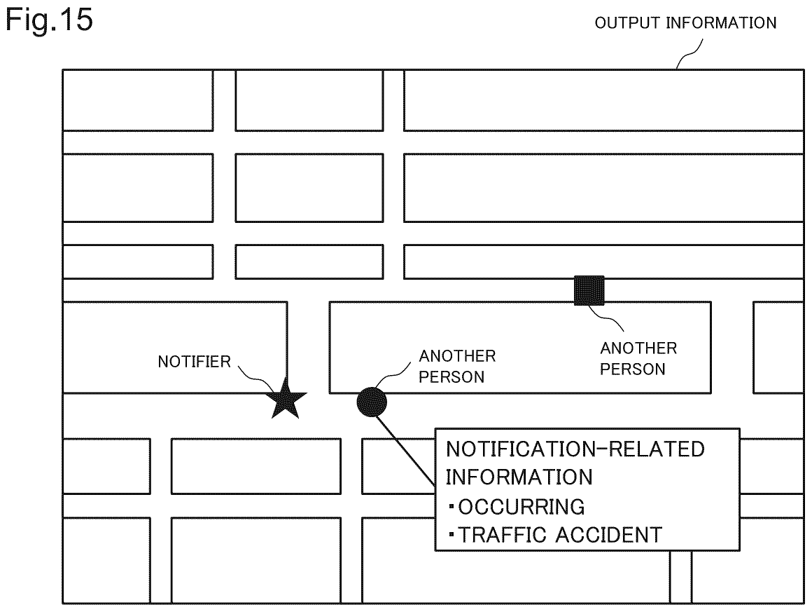

The output control unit 170 may output output information in which the notification-related information is superimposed on a map. FIG. 15 is a diagram illustrating an example of the output information. In the example of FIG. 15, the position of the notifier and the position of another person who is the owner of another communication terminal are illustrated on the map. The notifier is indicated by a star, and the other persons are indicated by circles and squares. That is, this example shows that there are two other communication terminals within a predetermined range from the communication terminal 10. In this manner, the output control unit 170 may output the positional relationship between the notifier and the owner of another communication terminal. In this example, notification-related information indicating that a case or an accident has occurred and that the occurred event is a traffic accident is indicated in the output information. That is, it is indicated that the person indicated by a circle input the occurrence of a traffic accident in the surroundings as the notification-related information. The notification-related information may be displayed, for example, by an operator of the command system 20 selecting a place indicating another person on the output information.

The output control unit 170 may perform different display according to the content of the notification-related information input by another person. For example, a person who has input that a case or an accident has occurred may be indicated by a circle on the map, and a person who has input that a case or an accident has occurred may be indicated by a square on the map. As a result, the operator of the command system 20 and the entity to be dispatched can intuitively grasp the content of the notification-related information.

In this manner, the output control unit 170 may output information in which the position of the another communication terminal is associated with the acquired information related to notification. The output control unit 170 is an example of an output control means.

### Operation Example of Notification Control Device 102

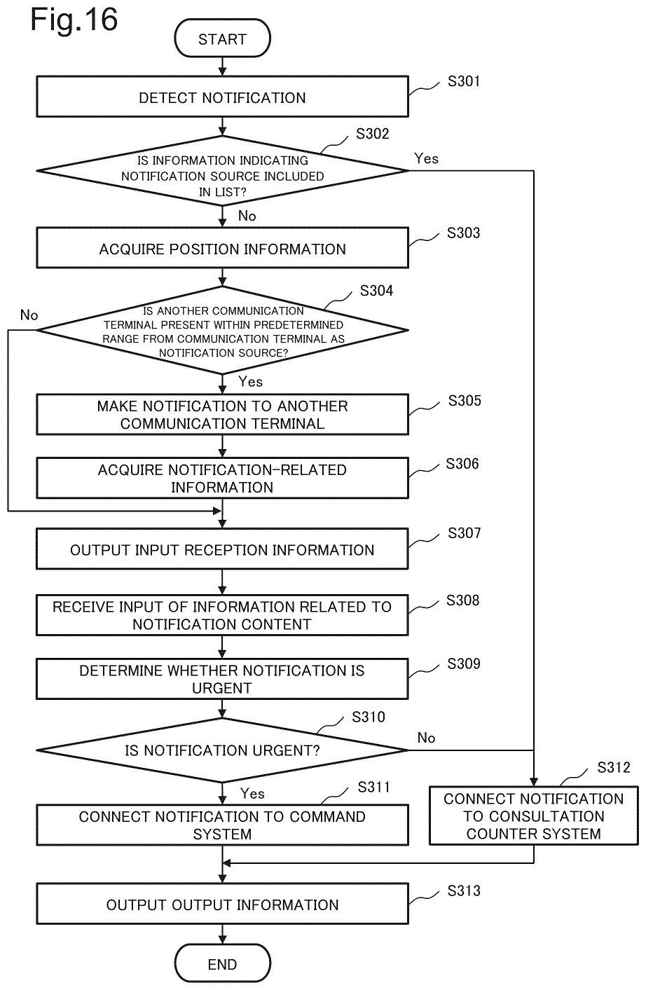

Next, an example of the operation of the notification control device 102 will be described with reference to FIG. 16.

FIG. 16 is a flowchart illustrating an example of the operation of the notification control device 102. Since the processing of S301 to S302 is similar to the processing of S201 to S202 of FIG. 11, the description thereof will be omitted.

In the case of “No” in the processing of S302, the position information acquisition unit 1601 acquires the position information of the plurality of communication terminals including the communication terminal 10 (S303). In a case where another communication terminal exists within the predetermined range from the communication terminal 10 as the notification source (“Yes” in S304), the notification unit 1602 notifies the another communication terminal (S305). For example, the notification unit 1602 transmits the second input reception information to the another communication terminal. When input is made by the owner of the another communication terminal, the notification-related information acquisition unit 1603 acquires the input information as the notification-related information (S306). In a case where no other communication terminal exists within the predetermined range from the communication terminal 10 as the notification source (“No” in S304), the notification control device 102 does not perform the processing of S305 and S306.

Since the processing of S307 to S312 is similar to the processing of S203 to S208 of FIG. 11, the description thereof will be omitted. The output control unit 170 outputs the output information to the command system 20.

This operation example is merely an example, and the operation of the notification control device 102 is not limited to this example. For example, the process of S313 may be performed after the process of S306. The processing of S304 to S306 may be performed after S307, or may be performed at the same timing as at least any of the processing after S307. That is, the processes of S304 to S306 and the processes of S307 to S312 may be performed in parallel.

As described above, the notification control device 102 according to the fourth example embodiment may acquire the position information from the communication terminal 10 and a terminal different from the communication terminal. The notification control device 102 may acquire information related to notification from another communication terminal present in a predetermined range from the position indicated by the position information of the communication terminal. As a result, the notification control device 102 can acquire information from a person near the notifier. That is, since the notification control device 102 can acquire more information related to notification, it is possible to support prompt handling by the emergency notification receiving organization or the entity to be dispatched.

The notification control device 102 according to the fourth example embodiment may transmit a notification for receiving an input of information related to notification to the another communication terminal before the notification is connected, and acquire the information related to notification as a response to the notification. As a result, the notification control device 102 can acquire information related to notification more quickly.

The notification control device 102 according to the fourth example embodiment may output information in which the position of the another communication terminal is associated with information related to the acquired notification. As a result, the emergency notification receiving organization or the entity to be dispatched can intuitively grasp information related to the notification.

### Third Modification

The notification-related information acquisition unit 1603 may give value data to the person who has input the notification-related information.

For example, the notification unit 1602 transmits the second input reception information to the another communication terminal. The owner of the another communication terminal inputs the notification-related information as a response to the second input reception information. The notification-related information acquisition unit 1603 acquires the notification-related information. At this time, the notification-related information acquisition unit 1603 gives value data to the owner of the another communication terminal who has input the notification-related information.

The value data is, for example, data indicating an economic value. The value data is, for example, data indicating money, but is not limited to this example. The value data may be data indicating a value similar to money, exchangeable for goods or services. For example, the value data may be points, electronic money, encrypted assets, electronic coupons, and the like. For example, the notification-related information acquisition unit 1603 further associates value data with owner information associated with identification information of an owner, an owner name, a contact address, and the like. The owner information is stored in, for example, a storage device (not illustrated) included in the notification control device 102 or a device outside the notification control device 102.

### Fourth Modification

The control unit 141 may receive a request to connect a notification from the command system 20. The control unit 141 may connect the notification to the command system 20 in response to the request.

For example, it is assumed that the determination unit 131 determines that there is no urgency in the notification. In this case, the notification is connected to, for example, the consultation counter system 30. On the other hand, it is assumed that the notification-related information acquired from the another communication terminal includes information indicating that a case or an accident involving human life has occurred. In this case, the operator in the command room recognizes that the notification is highly likely to be an urgent notification. Therefore, the operator in the command room operates the command system 20 to make a request to connect the notification to the command system 20. That is, the command system 20 receives a connection request that is a request to connect the notification to the command system 20, by the operation of the operator in the command room.

The command system 20 notifies the control unit 141 that a connection request has been made. The control unit 141 receives the connection request. The control unit 141 connects the notification to the command system 20.

In this manner, the control unit 141 may control a place where the notification is to be connected in response to the connection request from the emergency notification receiving organization (that is, the command system 20).

### Exemplary Configuration of Hardware of Notification Control Device

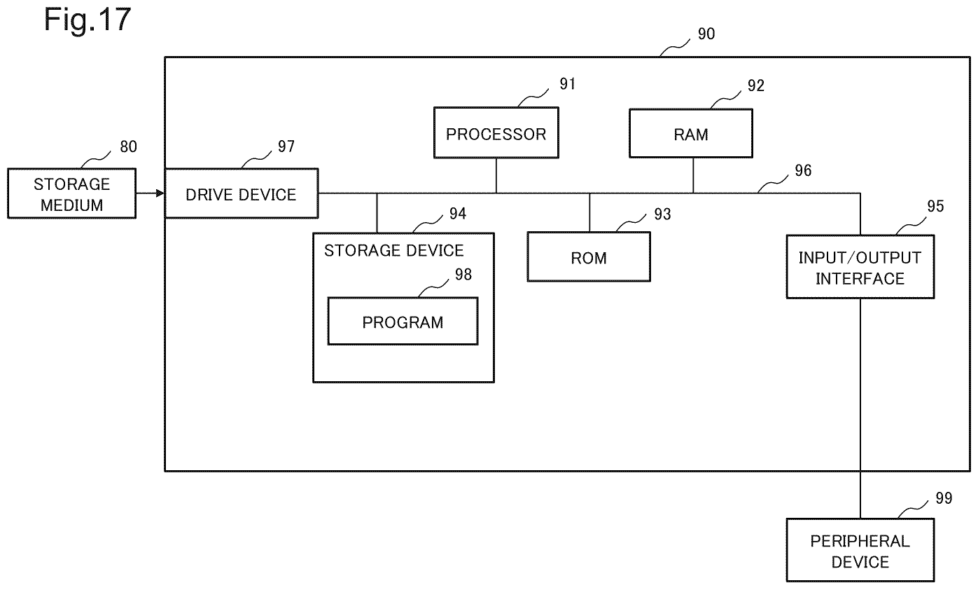

Hardware constituting the notification control device of each of the first, second, third, and the fourth example embodiments described above will be described. FIG. 17 is a block diagram illustrating an example of a hardware configuration of a computer device that implements the notification control device according to each example embodiment. In a computer device 90, the notification control device and the notification control method described in each example embodiment and each modification are achieved.

As illustrated in FIG. 17, the computer device 90 includes a processor 91, a random access memory (RAM) 92, a read only memory (ROM) 93, a storage device 94, an input/output interface 95, a bus 96, and a drive device 97. The notification control device may be achieved by a plurality of electric circuits.

The storage device 94 stores a program (computer program) 98. The processor 91 executes a program 98 of the notification control device using the RAM 92. Specifically, for example, the program 98 includes a program that causes a computer to execute the processes illustrated in FIGS. 3, 7, 11, and 16. In response to the processor 91 executing the program 98, the function of each component of the notification control device is implemented. The program 98 may be stored in the ROM 93. The program 98 may be recorded in a storage medium 80 and read using the drive device 97, or may be transmitted from an external device (not illustrated) to the computer device 90 via a network (not illustrated).

The input/output interface 95 exchanges data with a peripheral device (keyboard, mouse, display device, etc.) 99. The input/output interface 95 functions as a means for acquiring or outputting data. The bus 96 connects the components.

There are various modifications of the method of achieving the notification control device. For example, the notification control device can be achieved as a dedicated device. The notification control device can be achieved based on a combination of a plurality of devices.

A processing method of causing a storage medium to record a program for achieving each component in the functions of each example embodiment, reading the program recorded in the storage medium as a code, and a computer executing the program are also included in the scope of each example embodiment. That is, a computer-readable storage medium is also included in the scope of each example embodiment. A storage medium recording the above-described program and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. In addition, the program recorded in the storage medium is not limited to a program that executes processing by itself, and programs that operate on an operating system (OS) to execute processing in cooperation with other software and functions of an extension board are also included in the scope of each example embodiment.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

The above-described example embodiments and modifications can be appropriately combined.

Some or all of the above example embodiments may be described as the following Supplementary Notes, but are not limited to the following.

### Supplementary Note

### Supplementary Note 1

A notification control device including
a detection means for detecting a notification from a communication terminal owned by a notifier,
a reception means for receiving an input of information related to notification content from the notifier in accordance with the detection of the notification,
a determination means for determining, from the input information related to the notification content, whether the notification is urgent, and
a control means for controlling a place where the notification is to be connected based on whether the notification is urgent.

### Supplementary Note 2

The notification control device according to Supplementary Note 1, wherein
the control means connects the notification to an emergency notification receiving organization in a case where it is determined that there is urgency in the notification, and connects the notification to a connection place different from the emergency notification receiving organization in a case where it is determined that there is no urgency in the notification.

### Supplementary Note 3

The notification control device according to Supplementary Note 1 or 2, wherein
the reception means receives an input of at least one of a purpose of the notification and a type of an event that triggered the notification, and
the determination means determines whether the notification is urgent according to the received purpose or the received type of the event.

### Supplementary Note 4

The notification control device according to any one of Supplementary Notes 1 to 3, wherein
the reception means receives an input of presence or absence of an injured person, and
the determination means determines whether the notification is urgent according to the presence or absence of the injured person.

### Supplementary Note 5

The notification control device according to any one of Supplementary Notes 1 to 4, wherein
the determination means determines whether information indicating a notification source of the notification is included in a list, and
the control means performs control so as not to connect the notification to an emergency notification receiving organization in a case where the information indicating the notification source is included in the list.

### Supplementary Note 6

The notification control device according to any one of Supplementary Notes 1 to 5, further including
an information acquisition means for acquiring position information from the communication terminal and a terminal different from the communication terminal, wherein
the information acquisition means acquires information related to the notification from another communication terminal present in a predetermined range from a position indicated by position information of the communication terminal.

### Supplementary Note 7

The notification control device according to Supplementary Note 6, wherein
the information acquisition means transmits a notification for receiving an input of information related to the notification to the another communication terminal before the notification is connected, and acquires the information related to the notification as a response to the notification.

### Supplementary Note 8

The notification control device according to Supplementary Note 6 or 7, further including
an output control means for outputting information in which a position of the another communication terminal and the acquired information related to the notification are associated with each other.

### Supplementary Note 9

A notification control method including
detecting a notification by a communication terminal owned by a notifier,
receiving an input of information related to notification content from the notifier in response to the detection of the notification,
determining, from the input information related to the notification content, whether the notification is urgent, and
controlling a place where the notification is to be connected based on whether the notification is urgent.

### Supplementary Note 10

A computer-readable storage medium storing a program for causing a computer to execute the steps of
detecting a notification by a communication terminal owned by a notifier,
receiving an input of information related to notification content from the notifier in response to the detection of the notification,
determining, from the input information related to the notification content, whether the notification is urgent, and
controlling a place where the notification is to be connected based on whether the notification is urgent.

### REFERENCE SIGNS LIST

10 communication terminal
20 command system
30 consultation counter system
100, 101, 102 notification control device
110 detection unit
120 reception unit
130, 131 determination unit
140, 141 control unit
150 list generation unit
160 information acquisition unit
170 output control unit
1201 reception control unit
1202 input reception unit
1601 position information acquisition unit
1602 notification unit
1603 notification-related information acquisition unit

What is claimed is:

1. A notification control device comprising:
a detection circuit configured to detect a notification from a communication terminal owned by a notifier;
a reception circuit configured to receive an input of information related to notification content from the notifier in accordance with the detection of the notification;
a determination circuit configured to determine, from the input information related to the notification content, whether the notification is urgent; and
a control circuit configured to control a place where the notification is to be connected based on whether the notification is urgent.

2. The notification control device according to claim 1, wherein
the control circuit connects the notification to an emergency notification receiving organization in a case where it is determined that there is urgency in the notification, and connects the notification to a connection place different from the emergency notification receiving organization in a case where it is determined that there is no urgency in the notification.

3. The notification control device according to claim 1, wherein
the reception circuit receives an input of at least one of a purpose of the notification and a type of an event that triggered the notification, and
the determination circuit determines whether the notification is urgent according to the received purpose or the received type of the event.

4. The notification control device according to claim 1, wherein
the reception circuit receives an input of presence or absence of an injured person, and
the determination circuit determines whether the notification is urgent according to the presence or absence of the injured person.

5. The notification control device according to claim 1, wherein
the determination circuit determines whether information indicating a notification source of the notification is included in a list, and
the control circuit performs control so as not to connect the notification to an emergency notification receiving organization in a case where the information indicating the notification source is included in the list.

6. The notification control device according to claim 1, further comprising:
an information acquisition circuit configured to acquire position information from the communication terminal and a terminal different from the communication terminal, wherein
the information acquisition circuit acquires information related to the notification from another communication terminal present in a predetermined range from a position indicated by position information of the communication terminal.

7. The notification control device according to claim 6, wherein
the information acquisition circuit transmits a notification for receiving an input of information related to the notification to the another communication terminal before the notification is connected, and acquires the information related to the notification as a response to the notification.

8. The notification control device according to claim 6, further comprising:
an output control circuit configured to output information in which a position of the another communication terminal and the acquired information related to the notification are associated with each other.

9. A notification control method comprising:
detecting a notification by a communication terminal owned by a notifier;
receiving an input of information related to notification content from the notifier in response to the detection of the notification;
determining, from the input information related to the notification content, whether the notification is urgent; and
controlling a place where the notification is to be connected based on whether the notification is urgent.

10. A tangible and non-transitory computer-readable storage medium storing a program for causing a computer to execute the steps of:
detecting a notification by a communication terminal owned by a notifier;
receiving an input of information related to notification content from the notifier in response to the detection of the notification;
determining, from the input information related to the notification content, whether the notification is urgent; and
controlling a place where the notification is to be connected based on whether the notification is urgent.
